(19) United States
(12) Patent Application Publication
(10) Pub. No.: US 2012/0062671 A1
(43) Pub. Date: Mar. 15, 2012

(54) Plateless-transfer printing film, apparatus, and appliance using the same

(75) Inventor: Chung-Sheng Liu, Taipei (TW)

(73) Assignee: CLEVO CO., SUNCHUNG (TW)

(21) Appl. No.: 12/923,290

(22) Filed: Sep. 14, 2010

(51) Int. Cl. B41J 2/01

(52) U.S. Cl. 347/103

(57) ABSTRACT

A plateless-transfer printing apparatus having a plateless-transfer printing film and a transfer printing machine is disclosed. The plateless-transfer printing film includes a substrate and a transfer layer. The transfer layer has a release layer, a pattern layer, a white-ink layer and an adhesive layer. Those layers are orderly positioned on the substrate. In particular, the transfer printing machine has a pressure part, a heating part, an upper prop part and a lower prop part. An article-to-be-printed is firstly placed on the lower prop part. The plateless-transfer printing film positioned on the article is then heated by the heating part. Next, the pressure part presses both upper and lower prop parts, and the transfer printing film is formed on the surface of the article. It is featured that the pressure part evenly presses both the article and transfer printing film between the upper and lower prop parts.

### BACKGROUND OF THE INVENTION

1. Field of the Invention

The present invention relates to a transfer printing technology, in particular, to a plateless-transfer printing technology that transfers a pattern onto an article-to-be-printed.

2. Description of Related Art

Transfer printing technology has various types, including water-transfer printing, heat-transfer printing, and rub-transfer printing. The printed pattern may be obtained by a traditional printing or digital printing technology, including the plate-transfer printing or plateless-transfer printing in which the heat-transfer printing technology has been widely used for the various articles, and make the articles beautiful and unique.

The mentioned heat-transfer printing procedure mainly uses a transfer printing film to cover an article to be printed. Then it's to press and heat the transfer printing film, and the pattern on the film can be transferred on the article. It provides a stable transfer quality for a small sized plane. However, it's bad for the uneven plane or the plane having a vertical angle since the printed film is non-uniform or be easily fell off.

In the process of transfer printing, a hot-melt glue on the transfer printing film can be kept on the article to be printed as heating the film. If the heating temperature is too high, the color of the pattern may have chromatic aberration, or be vague. The too-high temperature may also make the article meet the surface damage or be melt especially if the article to be printed is not made of high-temperature resistant material.

### SUMMARY OF THE INVENTION

In view of the above described drawback of the conventional technology, provided is a plateless-transfer printing apparatus in accordance with the present invention. The plateless-transfer printing apparatus is to improve the transfer printing on the uneven plane or the plane having vertical angle rather than the conventional transfer printing film is not evenly printed on the article.

In one object of the invention, the provided plateless-transfer printing apparatus particularly allows a full-color pattern to be transferred on the article-to-be-printed

The plateless-transfer printing apparatus in one aspect of the present invention is adapted to a plastic or metal article. The apparatus particularly includes a plateless-transfer printing film and a transfer printing machine. The plateless-transfer printing film has a substrate and a transfer layer. The transfer layer is positioned upon the substrate. The transfer layer, in a bottom-up sequence, includes a release layer, a pattern layer, a white-ink layer, and an adhesive layer. The transfer printing machine includes a pressure part, a heating, part, a upper prop part and a lower prop part.

The heating part is used to heat the plateless-transfer printing film. An article-to-be-printed is fixed on the lower prop part. After the heating part heats the plateless-transfer printing film positioned on the article-to-be-printed, and the pressure part presses both the upper prop part and the lower prop part, the pattern on the printing film can be transferred on the surface of the article.

By means of the pressure part of the transfer printing machine pressing on the article and the film in the midst of the upper prop part and the lower prop part, a uniform transfer printing is accomplished. The pattern transferred on the surface of the article may not easily be fell off.

Yet further and additional benefits and improvements of the invention will be appreciated by others skilled in the art and those advantages and benefits of the invention will become apparent to those skilled in the art upon a reading and understanding of the following detailed description and drawings.

### BRIEF DESCRIPTION OF THE DRAWINGS

This invention may be practiced in certain physical forms and arrangements of the parts herein described, but a preferred embodiment of which will be described in detail in the specification and illustrated in the accompanying drawings which form a part hereof:

FIG. 1 shows a cross-sectional view of the plateless-transfer printing film in one embodiment of the present invention;

FIG. 2 shows a schematic diagram of one of the embodiment of the plateless-transfer printing film in accordance with the present invention;

FIG. 3 shows a schematic diagram of an appliance with full-color pattern in one embodiment of the present invention;

FIG. 4 shows a schematic diagram of one embodiment of the plateless-transfer printing apparatus in accordance with the present invention.

### DESCRIPTION OF THE PREFERRED EMBODIMENTS

The present invention uses a plateless-transfer printing film to perform a plateless transfer printing on an article-to-be-printed by a transfer printing machine. It is featured that the plateless-transfer printing film can be uniformly transferred on the article-to-be-printed. A full-color pattern may be therefore transferred onto the article.

In order to provide the more details of the descriptions relating to the present invention, the following statements in view of the drawings are to describe the technologies and means of the present invention.

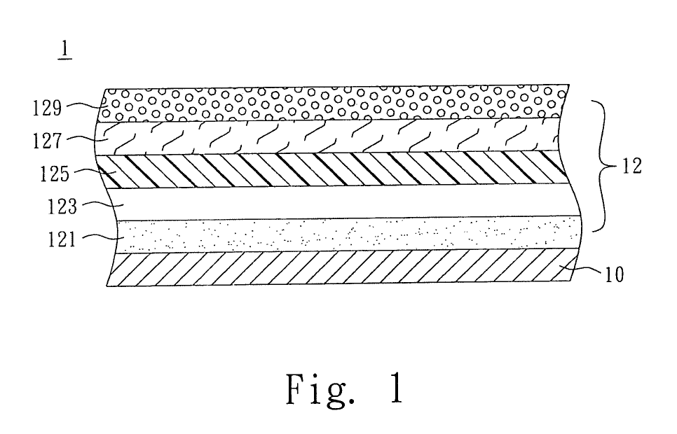

Reference is made to FIG. 1 illustrating a cross-sectional view of the embodiment of the plateless-transfer printing film in accordance with the present invention. A plateless-transfer printing film 1 in FIG. 1 particularly includes a substrate 10 and a transfer layer 12. The transfer layer 12 has a release layer 121, a transparent protective layer 123, a pattern layer 125, a white-ink layer 127, and an adhesive layer 129.

The plateless-transfer printing film 1 is formed by coating a transfer layer 12 on the substrate 10. The structure of the transfer layer 12, in sequence, includes the release layer 121, the transparent protective layer 123, the pattern layer 125, the white-ink layer 127, and the adhesive layer 129. The substrate 10 coated with the release layer 121 of the transfer layer 12 forms the film 1.

In particular, the substrate 10 may be made of a flexible material, such as a plastic film or a paper. Since the plastic film may not be adhered with ink easily, the release layer 121 is added. The release layer 121 may be a heat-fusing type, a heat-curing type, or a semi-heat-curing type releasing agent, which may prevent the pattern layer 125 apart from the substrate 10. The release layer 121 is selectively to release the transfer layer 12 from the substrate 10.

Further, the transparent protective layer 123 may be a transparent ink with anti solvent, a transparent acrylic glue, or a transparent hot-melt glue. This layer 123 is preferably the substance with features of high-temperature resistant and difficult to melt, so that the layer 123 can be the protection for the pattern layer 125 from chemical solvent erosion or physical scratch.

The pattern layer 125 has a pattern outputted from a laser printer or an ink-jet printer. In particular, the ink is made of environment-friendly solvent. The pattern layer 125 may be formed by repeating four times of coating with four-color coats and then baking. The colors may be the four primitive colors, namely yellow, red, blue and black. The coating step may be processed by a coating machine, and the baking step uses a hair dryer or a baking machine. Further, the white-ink layer 127 is kind of white paint. The adhesive layer 129 may a heat-transferable glue or resin.

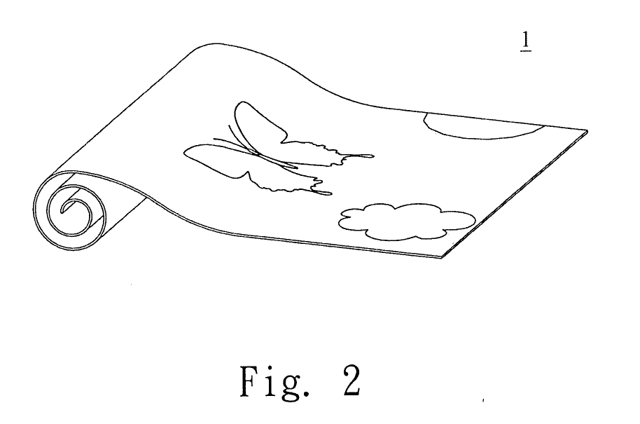

Reference is made further to FIG. 2 showing a schematic diagram of the embodiment of plateless-transfer printing film in accordance with the present invention. The plateless-transfer printing film 1 is a piece of or a roll of soft sheet. In the manufacturing process of the film 1, the coating machine or printer is used to coat or print the release layer 121 on the substrate 10 having 250 meshes. This mesh unit is number of strips per inch. Next, the coating machine or the printer is further used to form the pattern layer 125 above the release layer 121. The release layer 121 has more meshes and may not be easily passed through by the ink or coat of the pattern layer 125. In practice, the number of meshes may have least 400, or more, and they need to be painted evenly.

Furthermore, the step in the method is to coat or print the white-ink layer 127 upon the pattern layer 125. The white-ink layer 127 may have about 300 meshes for compensating the white color that the printer is incapable of printing out. This white-ink layer 127 may enhance the contrast of the pattern layer 125. At last, an adhesive layer 129 is coated by the coating machine or printed by the printer on the white-ink layer 127. In which the adhesive layer 129 is in a condition of melting material with strong stickiness under a suitable temperature, such as around 75˜120° C. However, the plateless-transfer printing film 1 has week stickiness in a condition of ordinary temperature, and the film 1 can be stored up in a roll.

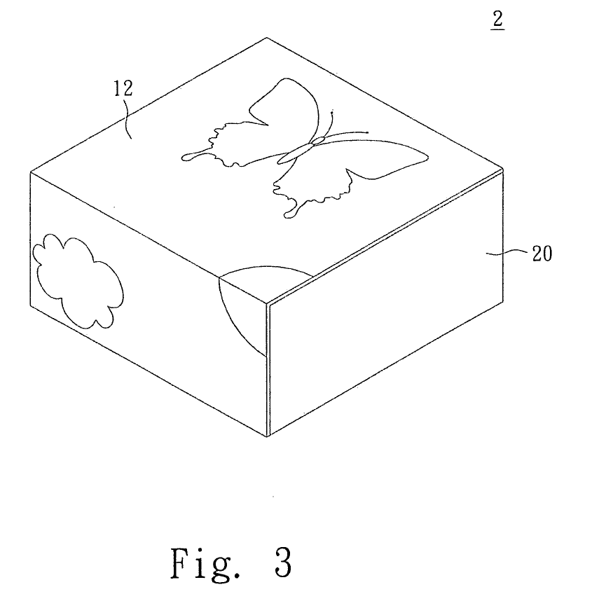

FIG. 3 schematically shows an appliance with a full-color pattern of the embodiment in accordance with the present invention. The appliance 2 includes an article-to-be-printed 20 and a transfer layer 12. For well adhering with the plateless-transfer printing film 1 and the article-to-be-printed 20, the material of the adhesive layer 129 needs to be compatible with the article-to-be-printed 20. That material has a strong stickiness under a specific temperature, and the adhesive layer 129 may closely adhered to the surface of article-to-be-printed 20 as the temperature may not reach the melting point of the article.

According to one of the embodiments, the adhesive layer 129 may have lower melting point, it meets around 75 to 100° C. The related transfer-printing may be processed by a low-temperature heating process in order to prevent the article 20 from melting clown or damage. Then the process is cooled down to a lower temperature, around 40° C., after the heating process. That means, the transfer layer 12 can be released from the substrate 10 evenly as the release layer 121 is cooled down or under a liquid state. The mentioned transfer layer 12 may include the transparent protective layer 123; or alternatively an anti-solvent transparent ink is coated on the pattern layer 125 after releasing the substrate 10. Therefore, a transparent protective layer 123 is formed for protecting the pattern layer 125 from chemical solvent erosion or physical scratch.

In one other embodiment of the invention, the transfer layer 12 may not include the adhesive layer 129, but the material or the surface coat of the article-to-be-printed 20 may adhere to the pattern layer 125 after heating. The pattern of the pattern layer 125 may be customized to be any figure or text outputted by a printer in accordance with the requirements. It is featured that the full-color pattern advantages the uniqueness of the appliance 2.

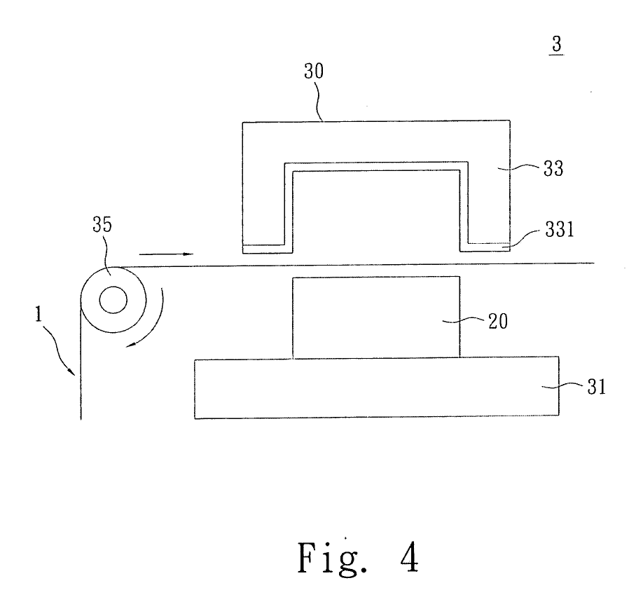

Reference is made to FIG. 4 showing a schematic diagram of the plateless-transfer printing apparatus of the present invention. The shown plateless-transfer printing apparatus 3 includes a plateless-transfer printing film 1 and a transfer printing machine 30. The transfer printing machine 30 particularly includes a upper prop part 33, a lower prop part 31, a pressure part (not shown), a heating part (not shown), and a transfer part 35. The lower prop part 31 is used to fix the article-to-be-printed 20. The design of both lower prop part 31 and the upper prop part 33 is fit with the appearance of article-to-be-printed 20, and completely covering the article 20.

According to the current embodiment, the lower prop part 31 and the opposite upper prop part 33 are respectively the concave and the convex, or any opposite curve surfaces. The transfer part 35 is used to input the plateless-transfer printing film 1 to the transfer printing machine 30 evenly. The transfer part 35 can be a rotatable axis or a rolling cylinder. Before inputting the film 1 to the transfer printing machine 30, the plateless-transfer printing film 1 is heated to a certain temperature by the heating part, it is around 75 to 100° C. By which, the plateless-transfer printing film 1 has stickiness.

Meanwhile, the plateless-transfer printing film 1 is positioned on the surface of the article-to-be-printed 20, and in the midst of the upper prop part 33 and the lower prop part 31. The pressure part operates a pressure on the upper prop part 33 and the lower prop part 31. Then the upper prop part 33 and the lower prop part 31 may be closely pressed. The plateless-transfer printing film 1 may be evenly and non-bubbly transferred onto the article 20 after heating. The transfer printing machine 30 further includes a drawing part (not shown), which may vacuum the inner of the transfer printing machine 30 for assuring no bubble existed between the plateless-transfer printing film 1 and the article-to-be-printed 20. In addition, a silicone layer 331 is further provided between the upper prop part 33 and the lower prop part 31. While the surface of the article-to-be-printed 20 is uneven or having a vertical angle, the silicone layer 331 assists providing a force more uniformly. The mentioned silicone layer 331 is preferably disposed in the midst of the upper prop part 33 and the article-to-be-printed 20. After the pressure part presses the upper prop part 33 and the lower prop part 31, the plateless-transfer printing film 1 is more properly transferred onto the article 20. The printing quality is enhanced.

In summation of the above description, the scheme of low-temperature heating, and vacuum pressing is used to transfer the plateless-transfer printing film onto the article-to-be-printed, in particular to the uneven surface or the surface having vertical angle. Since bubbles existed into the space between the printing film and the article-to-be-printed may cause damage, the claimed apparatus particularly provides above described solution for the traditional printed article.

The invention has been described using an exemplary preferred embodiment. However, it is to be understood that the scope of the invention is not limited to the disclosed embodiment. On the contrary, it is intended to cover various modifications and similar arrangements. The scope of the claims, therefore, should be accorded the broadest interpretation so as to encompass all such modifications and similar arrangements.

What is claimed is:

1. A plateless-transfer printing film, comprising:
a substrate; and
a transfer layer, disposed on the substrate, comprising:
a release layer, positioned on the substrate, selectively releasing the substrate and the transfer layer;
a pattern layer, positioned on the release layer, being a color-ink layer;
a white-ink layer, positioned on the pattern layer; and
an adhesive layer, positioned on the white-ink layer, providing an adhesion for the plateless-transfer printing film.

2. The film of the claim 1, wherein the substrate is a plastic film or a paper.

3. The film of the claim 1, wherein the pattern layer is formed by an output of an ink-jet printer or a laser printer.

4. The film of the claim 1, wherein the release layer is a heat-fusing type, a heat-curing type, or a semi-heat-curing type releasing agent.

5. The film of the claim 1, further comprising a transparent protective layer which is positioned on the release layer.

6. A plateless-transfer printing apparatus, comprising:
a plateless-transfer printing film recited in claim 1; and
a transfer printing machine, comprising:
a heating part, heating the transfer printing film;
a lower prop part, fixing an article-to-be-printed;
a upper prop part, opposite to the lower prop part; and
a pressure part, pressing the upper prop part and the lower prop part, and the plateless-transfer printing film being transferred on a surface of the article-to-be-printed.

7. The apparatus of claim 6, further comprising a silicone layer, which is positioned in the midst of the upper prop part and the article-to-be-printed.

8. The apparatus of claim 6, wherein the pattern layer is formed by an output from an ink-jet printer or a laser printer.

9. The apparatus of claim 6, wherein the substrate is a plastic film or a paper.

10. The apparatus of claim 6, wherein the release layer is a heat-fusing type, a heat-curing type, or a semi-heat-curing type releasing agent.

11. The apparatus of claim 6, wherein the upper prop part is opposite to the lower prop part, and being a concave and a convex respectively.

12. An appliance with full-color pattern, comprising:
an article-to-be-printed;
an adhesive layer, positioned on the article-to-be-printed;
a white-ink layer, positioned on the adhesive layer; and
a pattern layer, positioned on the white-ink layer, and having color ink.

13. The appliance of claim 12, wherein material of the adhesive layer and material of the article-to-be-printed are compatible.

14. The appliance of claim 13, wherein the adhesive layer is transparent hot-melt glue.

15. The appliance of claim 12, wherein the pattern layer has a full-color picture or text outputted from a printer.

16. The appliance of claim 12, wherein the pattern layer is formed by a plurality of times of color printing and baking via a plate-transfer printing mold.

17. The appliance of claim 12, further comprising a transparent protective layer which is positioned on the pattern layer.
